(19) United States
(12) Patent Application Publication
(10) Pub. No.: US 2010/0131375 A1
(43) Pub. Date: May 27, 2010

(54) MONEY TRANSFER PAYMENTS FOR MOBILE WIRELESS DEVICE PREPAID SERVICES

(75) Inventors: Peter A. Kramer, Arlington, VA (US); William J. Peters, Leesburg, VA (US); Thilo Rusche, Arlington, VA (US); Mark R. Smith, Warrenton, VA (US)

Correspondence Address: EDELL, SHAPIRO & FINNAN, LLC, 1901 RESEARCH BOULEVARD, SUITE 400, ROCKVILLE, MD, 20850, US

(73) Assignee: RECARGAX, INC., Leesburg, VA (US)

(21) Appl. No.: 12/612,212

(22) Filed: Nov. 4, 2009

Related U.S. Application Data
(60) Provisional application No. 61/118,106, filed on Nov. 26, 2008.

(51) Int. Cl. G06Q 20/00; G06Q 50/00; G06Q 30/00; G06Q 10/00; H04W 4/12

(52) U.S. Cl. 705/17; 705/40; 705/21; 705/30; 455/466

(57) ABSTRACT

Systems and methods for facilitating money transfer payments for mobile wireless device prepaid services include receiving, from a vendor location, a money transfer payment for mobile wireless device prepaid services fulfillment request including a mobile wireless device phone number and a corresponding payment amount. A destination wireless service provider that serves the mobile wireless device is identified based on the phone number, and the payment for mobile wireless device prepaid services request or a formatted version thereof is delivered to the destination wireless service provider. A fulfillment confirmation or denial associated with the payment for mobile wireless device prepaid services fulfillment request is thereafter received, and when a fulfillment confirmation is received, payment is provided to the destination wireless service provider.

This application claims the benefit of U.S. Provisional Application No. 61/118,106 filed Nov. 26, 2008, the entirety of which is incorporated herein by reference.

### BACKGROUND OF THE INVENTION

Embodiments of the present invention relate generally to the field of money transfer payments and more particularly to money transfer payments, systems and methods to initiate, facilitate, process, and/or perform payments for mobile wireless device prepaid services.

Present money transfer payments for mobile wireless device prepaid services procedures typically involve a consumer going to a retail location and purchasing a prepaid wireless services card associated with the wireless service provider. The prepaid wireless services card has a fixed dollar amount value and is presented to the retailer for purchase and initial activation in order to complete the payment fulfillment process. The customer service agent collects the payment remittance from the consumer and then activates the prepaid wireless services card via a proprietary terminal. The consumer then completes the two-part activation process by providing a personal identification number or PIN code, which is obtained from the prepaid wireless services card, to a customer service representative (CSR), an interactive voice response unit (IVR), a website, or the like. Typically, this procedure is followed for each subsequent money transfer payment for mobile wireless device prepaid services. While this conventional procedure functions well for many people, some consumers fail to enter the PIN code properly, or fail to properly complete the activation process, leading to incomplete transactions and frustration. In addition, this increases the wireless service provider's operating cost by increasing customer care calls and contributing to customer “churn.” Moreover, consumers are obligated to visit retail outlets that sell appropriate prepaid cards.

### BRIEF SUMMARY OF THE INVENTION

The present invention is particularly useful for making payments for mobile wireless device prepaid services without the need to separately purchase a prepaid wireless services card. In this manner, the customer can initiate the payment for mobile wireless device prepaid services while attending to other shopping or errands, or while at a location not designated solely for payments for mobile wireless device prepaid services.

In one embodiment of the present invention, there is provided a method of facilitating money transfer payments for mobile wireless device prepaid services including receiving, from a vendor location, a money transfer payment for mobile wireless device prepaid services request associated with a mobile wireless device phone number. The method further includes receiving a fulfillment request initiated by a customer, collecting a customer data set comprised of the mobile wireless device phone number and the payment amount, and authorizing a money transfer payment for mobile wireless device prepaid services to the wireless service provider associated with the mobile wireless device phone number. The money transfer payment for mobile wireless device prepaid services transaction record includes, in some embodiments, an account identifier including the mobile wireless device phone number, a transaction code and additional data fields used to uniquely identify the transaction.

In one aspect, the method includes associating a mobile wireless device phone number with the correct wireless service provider, and providing a connection to the wireless service provider's network to facilitate the money transfer payment for mobile wireless device prepaid services. In this manner, a money transfer payment for mobile wireless device prepaid services may be initiated or requested at the vendor location. The vendor location, which may include a point-of-sale device, a customer service representative (CSR) or retail agent, and may be a retail outlet, vendor or merchant (e.g., grocery store, gas station, money transfer agent, shopping mall, airport, or the like), can be used to facilitate money transfer payments for mobile wireless device prepaid services between customers and wireless service providers.

Embodiments of the present invention also provide systems for initiating, processing, facilitating and/or performing money transfer payments for mobile wireless device prepaid services. One such system includes a host computer system having a processor coupled to a database. The host computer system further includes code for performing various methods or method steps of the present invention. In a particular embodiment, the code includes code for receiving a fulfillment request associated with a money transfer payment for mobile wireless device prepaid services record and collecting a customer data set, and for authorizing a money transfer payment for mobile wireless device prepaid services associated with the money transfer payment for mobile wireless device prepaid services record.

In some aspects, the system includes a point-of-sale device disposed at the vendor location. The point-of-sale device is configured to receive the money transfer payment for mobile wireless device prepaid services request from the customer service representative or retail agent and to provide the money transfer payment for mobile wireless device prepaid services request to the host computer system. In some aspects, the point-of-sale device receives a mobile wireless device phone number and payment amount associated with the money transfer payment for mobile wireless device prepaid services record, and initiates the money transfer payment for mobile wireless device prepaid services fulfillment request. Initiation of the money transfer payment for mobile wireless device prepaid services fulfillment request may occur, in some aspects, when the point-of-sale device sends the mobile wireless device phone number and payment amount to the host. In one aspect, the host computer system includes a first host computer having the code for establishing the money transfer payment for mobile wireless device prepaid services record and a second host computer having the code for determining the associated wireless service provider to whom payment should be directed, and a third host computer having the code for formatting, authorizing and delivering the money transfer payment for mobile wireless device prepaid services associated with the money transfer payment for mobile wireless device prepaid services record.

Other objects, features and advantages of the present invention will become more fully apparent from the following detailed description, the appended claims, and the accompanying drawings.

### BRIEF DESCRIPTION OF THE DRAWINGS

FIG. 1 is a schematic diagram of a system for facilitating money transfer payments for mobile wireless device prepaid services according to an embodiment of the present invention; and

FIG. 2 is a combination block and flow diagram of a system and method according to an embodiment of the present invention.

### DETAILED DESCRIPTION OF THE INVENTION

The present invention includes systems and methods that initiate, facilitate, process and/or perform money transfer payments for mobile wireless device prepaid services between customers and wireless service providers. The embodiments of the present invention may be particularly useful for customers who want to make payments for mobile wireless device prepaid services without having to purchase a prepaid wireless services card associated with the wireless service provider and having a fixed dollar amount value, presenting the prepaid wireless services card to the retailer for purchase and initial activation, and then completing the activation and fulfillment process by providing a series of numbers or codes from the prepaid wireless service card to a customer service representative (CSR), an interactive voice response unit (IVR), a website, or the like. The number of locations at which a money transfer payment for mobile wireless device prepaid services can be initiated is increased through use of the systems and methods of the present invention. Some embodiments result in increased transaction speed and improved convenience to the customers.

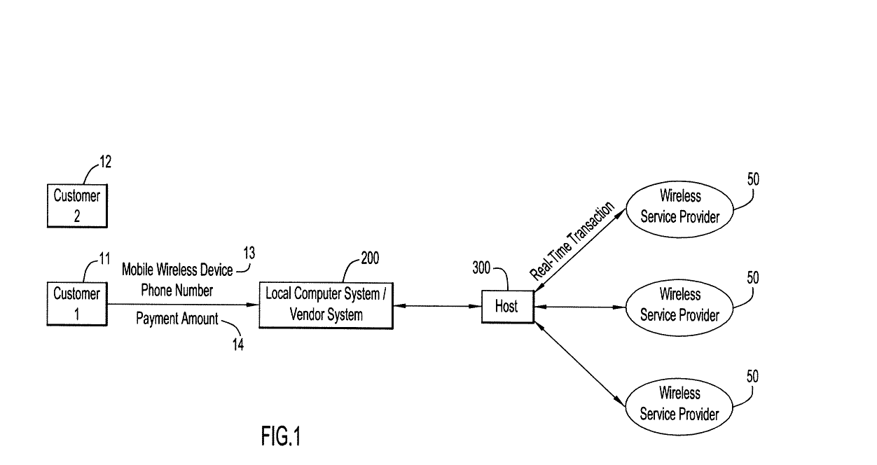

With reference to FIG. 1, the customer requests the fulfillment of the money transfer payment for mobile wireless device prepaid services by communicating with a retail organization. The money transfer payment for mobile wireless device prepaid services fulfillment can be accomplished a number of ways within the scope of the present invention. For example, a first Customer 11 may enter a money transfer payment for mobile wireless device prepaid services location, such as a location enabled in accordance with the functionality described herein, and provide relevant information in the form of a mobile wireless device phone number 13 and a payment amount 14 to a customer service representative (CSR) for first Customer 11. The CSR enters the collected information into a computer-based system using appropriate software.

In another embodiment, the customer requests the fulfillment of the money transfer payment for mobile wireless device prepaid services by communicating with a retail organization. A first Customer 11 may enter a money transfer payment for mobile wireless device prepaid services location, and provide relevant information in the form of a mobile wireless device phone number 13 for a second Customer 12 and a payment amount 14 to a customer service representative (CSR). The CSR enters the collected information into a computer-based system using appropriate software.

Alternatively, the money transfer payment for mobile wireless device prepaid services fulfillment request may be accomplished when first Customer 11 enters customer information into a money transfer organization website. In these embodiments, Customer 11 provides the money transfer organization with the mobile wireless device phone number 13, and the payment amount 14.

During the payment for mobile wireless device prepaid services fulfillment request process, in one embodiment first Customer 11 is provided with a money transfer payment for mobile wireless device prepaid services payment number. The money transfer payment for mobile wireless device prepaid services payment number may take a variety of forms within the scope of the present invention, including being a string of alphanumeric characters. The money transfer payment for mobile wireless device prepaid services payment number may be provided to first Customer 11 through a variety of mechanisms within the scope of the present invention. For example, the money transfer payment number may be provided to first Customer 11 when they request payment for mobile wireless device prepaid services fulfillment, and upon completion of the payment for mobile wireless device prepaid services transaction.

In another embodiment, during the payment for mobile wireless device prepaid services fulfillment request process, first Customer 11 is provided with a money transfer payment for mobile wireless device prepaid services account balance, or payment due. The money transfer payment for mobile wireless device prepaid services account balance, or payment due may be provided to first Customer 11 through a variety of mechanisms within the scope of the present invention. For example, the money transfer account balance, or payment due may be provided to first Customer 11 when they request payment for mobile wireless device prepaid services fulfillment, and upon completion of the payment for mobile wireless device prepaid services transaction. In one embodiment, the account balance, or payment due, associated with the mobile wireless device phone number may be determined and returned to the customer's mobile wireless device via a Customer Notification 110 using, e.g., the Short Message Service (SMS) Multimedia Message Service (MMS) or email. In another embodiment, the account balance, or payment due, associated with the mobile wireless device phone number may be determined and returned to the vendor platform 200 (also referred to herein as “Local computer system”).

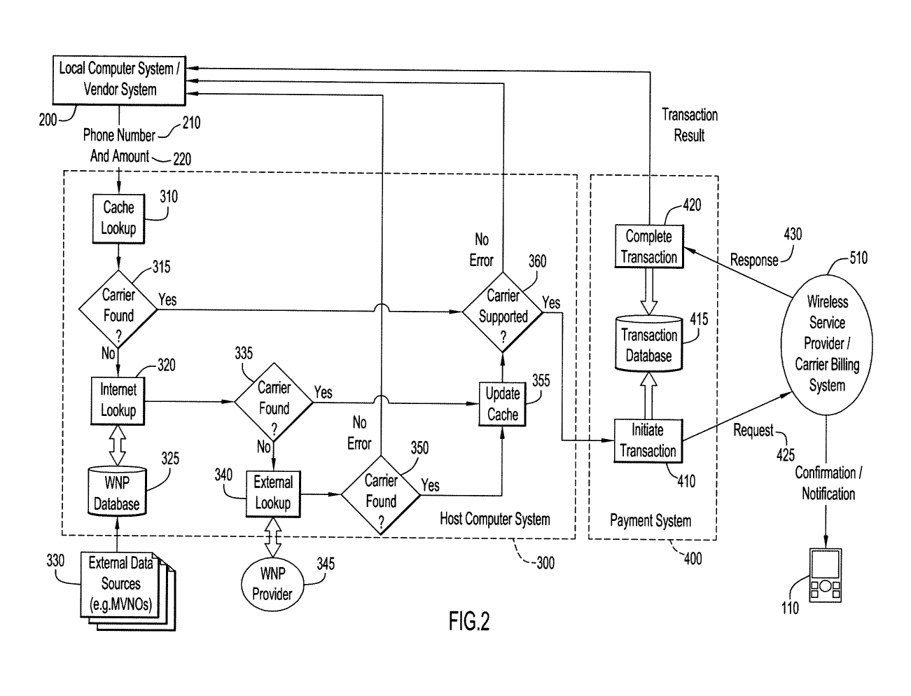

FIG. 2 depicts, among other things, a system for initiating, facilitating, processing and/or performing money transfer payments for mobile wireless device prepaid services according to embodiments of the present invention. Local computer system 200 includes a terminal or browser connected to a computer network that may be used to capture, transmit and/or receive information to and from host computer Number Lookup System or Host System 300 and Payment System 400. In one embodiment, the Local computer system 200 comprises a server or other computer-based apparatus for creating and maintaining money transfer payment for mobile wireless device prepaid services requests associated with mobile wireless device phone numbers. Local computer system 200, in one embodiment, is operated by a third party such as retail vendor or money transfer organization.

Local computer system 200 may comprise or be coupled to a server maintaining a terminal or browser into which the vendor or retail CSR inputs money transfer payment for mobile wireless device prepaid services fulfillment data. Similarly, Local computer system 200 may have other user interfaces by which a customer enters money transfer payment for mobile wireless device prepaid services fulfillment information. For example, Local computer system 200 may comprise or be coupled to a server maintaining a terminal or browser into which first Customer 11 inputs money transfer payment for mobile wireless device prepaid services fulfillment data. In one embodiment, Customer 11 inputs money transfer payment for mobile wireless device prepaid services fulfillment data for the mobile wireless device phone number of Customer 11. In another embodiment, Customer 11 inputs money transfer payment for mobile wireless device prepaid services fulfillment data for the mobile wireless device phone number of Customer 12 (see FIG. 1).

Local computer system 200 further includes the hardware and software necessary to monitor, authorize, and initiate money transfer payments for mobile wireless device prepaid services between first Customer 11 and wireless service provider or Wireless Service Provider/Carrier Billing System 510. Local computer system 200 may be coupled to Host System 300 and Payment System 400 either directly or through a network. The network may include telephone networks, wide area networks, the Internet, wireless networks, and the like. Furthermore, depending on the type of processing device used to transmit the information, such devices may also be coupled to a financial network such as a credit card network or Automated Teller Machine (ATM) network, or may have a direct connection to other host computer systems. In addition, Local computer system 200 may be coupled to a terminal or browser or other interface mechanism that allows Customer 11 and/or a CSR to interface with the Host System 300 and Payment System 400.

Host computer system 300 includes the hardware (including processor(s), physical data storage devices, electronic interconnects, etc.) and software necessary to communicate with Local computer system 200 and other entities, and determine the Wireless Service Provider 50 associated with the mobile wireless device Phone Number 210 provided by Customer 11. The Host Computer System 300 is comprised of several elements designed to determine the validity of syntax, and correctly identify the Wireless Service Provider 50 associated with the mobile wireless device Phone Number 210 provided by Customer 11. Cache Lookup 310 may first attempt to resolve the Wireless Service Provider 50 from an internal data source.

If Carrier Found 315 determines Cache Lookup 310 contained the mobile wireless device phone number then inquiry Carrier Supported 360 is executed. Carrier Supported 360 determines whether or not the Payment System 400 supports a connection to the Wireless Service Provider/Carrier Billing System 510 associated with the mobile wireless device Phone Number 210 provided by Customer 11 and the Wireless Service Provider 50 identified by Cache Lookup 310. If so, then a payment transaction is initiated via Initiate Transaction 410. If Carrier Supported 360 determines there is no connection to the identified Wireless Service Provider/Carrier Billing System 510 associated with the mobile wireless device Phone Number 210 provided by Customer 11 and the Wireless Service Provider 50 identified by Cache Lookup 310, then an error is returned to the Local computer system 200. In the case of an “error”, the payment transaction cannot be completed.

If Carrier Found 315 determines Cache Lookup 310 did not contain the mobile wireless device phone number, then Internal Lookup 320 is executed. Internal Lookup 320 is connected to wireless number portability (WNP) Database 325. In this embodiment, WNP Database 325 houses valid mobile wireless device phone numbers associated with a Mobile Virtual Network Operator (MVNO) along with their corresponding Wireless Service Provider 50. Data is routinely gathered from External Data Sources 330, which includes data from the MVNOs. After Internal Lookup 320 is executed then Carrier Found 335 is invoked. If Carrier Found 335 determines the mobile wireless device Phone Number 210 is found, and the corresponding Wireless Service Provider 50 identified, then Carrier Found 335 routes the transaction to Update Cache 355. After Update Cache 355 is completed, Carrier Supported 360 is executed. Carrier Supported 360 determines whether or not the Payment System 400 supports a connection to the Wireless Service Provider/Carrier Billing System 510 associated with the mobile wireless device Phone Number 210 provided by Customer 11 and the Wireless Service Provider 50 identified by Internal Lookup 320. If so, then a payment transaction is initiated via Initiate Transaction 410. If Carrier Supported 360 determines there is no connection to the identified Wireless Service Provider/Carrier Billing System 510 associated with the mobile wireless device Phone Number 210 provided by Customer 11 and identified by Internal Lookup 320, then an error is returned to the Local computer system 200. In the case of an “error”, the payment transaction cannot be completed.

If Carrier Found 335 determines Internal Lookup 320 did not contain the mobile wireless device Phone Number 210 then Carrier Found 335 invokes External Lookup 340. External Lookup 340 is connected to WNP Provider 345. In this embodiment, WNP Provider 345 houses all valid mobile wireless device phone numbers along with their associated wireless service provider. Data is routinely gathered from external data sources, and may include sources such as the Wireless Service Providers 50 as well as third party data providers. After External Lookup 340 is executed then Carrier Found 350 is invoked. If Carrier Found 350 determines the mobile wireless device Phone Number 210 is found, and the corresponding Wireless Service Provider 50 identified, then Carrier Found 350 routes the transaction to Update Cache 355. After Update Cache 355 is completed, Carrier Supported 360 is executed. Carrier Supported 360 determines whether or not the Payment System 400 supports a connection to the Wireless Service Provider/Carrier Billing System 510 associated with the mobile wireless device Phone Number 210 provided by Customer 11 and the Wireless Service Provider 50 identified by External Lookup 340. If so, then a payment transaction is initiated via Initiate Transaction 410. If Carrier Supported 360 determines there is no connection to the identified Wireless Service Provider/Carrier Billing System 510 associated with the mobile wireless device Phone Number 210 provided by Customer 11 and identified by External Lookup 340, then an error is returned to the Local computer system 200. If Carrier Found 350 determines External Lookup 340 did not contain the mobile wireless device Phone Number 210 then an error is returned to the Local computer system 200. In the case of an “error”, the payment transaction cannot be completed.

While WNP Database 325 and WNP Provider 345 are depicted as separate systems, in some embodiments, these elements may comprise a single system with all functionality housed within system 325. In this embodiment, WNP Database 325 houses all valid mobile wireless device phone numbers and their associated Wireless Service Provider 50, in addition to valid mobile wireless device phone numbers associated with a Mobile Virtual Network Operator (MVNO) along with their corresponding Wireless Service Provider 50. Data is routinely gathered from External Data Sources 330, which includes data from the MVNOs and WNP Providers 345. In this embodiment, Internal Lookup 320 performs the determination of the Wireless Service Provider 50. Internal Lookup 320 is executed and upon completion, Carrier Found 335 is invoked. If Carrier Found 335 determines the mobile wireless device Phone Number 210 is found, and the corresponding Wireless Service Provider 50 identified, then Carrier Found 335 routes the transaction to Update Cache 355. After Update Cache 355 is completed, Carrier Supported 360 is executed. Carrier Supported 360 determines whether or not the Payment System 400 supports a connection to the Wireless Service Provider/Carrier Billing System 510 associated with the mobile wireless device Phone Number 210 provided by Customer 11 and the Wireless Service Provider 50 identified by Internal Lookup 320. If so, then a payment transaction is initiated via Initiate Transaction 410. If Carrier Supported 360 determines there is no connection to the identified Wireless Service Provider/Carrier Billing System 510 associated with the mobile wireless device Phone Number 210 provided by Customer 11 and identified by Internal Lookup 320, then an error is returned to the Local computer system 200. If Carrier Found 335 determines Internal Lookup 320 did not contain the mobile wireless device Phone Number 210 then an error is returned to the Local computer system 200. In the case of an “error”, the payment transaction cannot be completed.

Payment System 400 includes the hardware and software necessary to monitor, initiate, and process money transfer payments for mobile wireless device prepaid services between Customer 11 and Wireless Service Provider/Carrier Billing System 510. Initiate Transaction 410 updates the Transaction Database 415 and processes Request 425 to deliver a money transfer payment for mobile wireless device prepaid services request including mobile wireless device Phone Number 210 and Payment Amount 220 to the Wireless Service Provider/Carrier Billing System 510. Processing may include, e.g., formatting the original request so that the thus-formatted request is in a format acceptable to the Wireless Service Provider/Carrier Billing System 510. The required format may be proprietary or conform to a public standard. Response 430 is received from Wireless Service Provider/Carrier Billing System 510. The Response 430 may be a successful or unsuccessful transaction. Complete Transaction 420 updates Transaction Database 415 with a result status of, e.g., successful or unsuccessful. In the event Response 430 is not received, Complete Transaction 420 assigns an unsuccessful status after a predefined period of time. After updating the Transaction Database 415, Complete Transaction 420 passes the transaction status to the Local computer system 200.

In one embodiment, the Host System 300 settles, financially, with the Wireless Service Provider 50 and the vendor that operates Local computer system 200. This may be accomplished using electronic funds transfer (EFT), an automated clearing house (ACH) facility, or any other means that ensures that the Wireless Service Provider 50 is provided with an amount of funds equivalent to an amount of prepaid service that is the subject of the request for prepaid services and that is supplied to the customer 11, 12. Fees, commissions, etc., may also be allocated via this settlement process.

In some embodiments, portions of Local computer system 200 are found in retail outlets, merchants, vendors, and the like, such as grocery stores, gas stations, shopping malls, money transfer agents, airports, and the like. In one embodiment, a retail outlet has an associated vendor or Local computer system 200 coupled to a point-of-sale (POS) device. This coupling may be a direct coupling, or may be an electronic coupling through a network. A direct coupling between a vendor, i.e., Local computer system 200, and a point-of-sale device may comprise, for example, a point-of-sale terminal in a store location, physically or wirelessly coupled with Local computer system 200. In some embodiments, Local computer system 200 comprises a server, a computer, or the like, which may be located in a back room of the store or retail location.

In some embodiments, the money transfer payment for mobile wireless device prepaid services amount is collected from Customer 11, and any money transfer payment for mobile wireless device prepaid services fees are deducted from the collected amount. In other embodiments, the POS device is instructed by Local computer system 200 to collect a money transfer payment for mobile wireless device prepaid services fee in addition to the money transfer payment for mobile wireless device prepaid services payment amount. In some embodiments, the money transfer fee, if applicable, is a variable amount such as a percentage of the money transfer payment for mobile wireless device prepaid services amount. The collection of the fee would be similar to applying a sales tax to an item being purchased at POS device. In other embodiments, the money transfer fee, if applicable, is a fixed dollar amount. Additional money transfer payment for mobile wireless device prepaid services fees may be used in alternative embodiments, such as a sliding fee scale (e.g., a one-dollar fee for every twenty dollars of payment for mobile wireless device prepaid services.) In some embodiments, Local computer system 200 maintains a money transfer payment for mobile wireless device prepaid services fee schedule. The money transfer payment for mobile wireless device prepaid services fee may include a fee to be paid the operator(s) of host system 400, and may include a fee to be paid to the operator of Local computer system 200. In some embodiments the fee is not paid directly by the Customer, but is instead collected/allocated from the payment made by the customer 11.

When Customer 11 tenders payment for items purchased at the store and/or for a money transfer payment for mobile wireless device prepaid services, this payment may require further authorization. For example, if Customer 11 is not paying with cash, but instead is paying with a credit card, a standard credit card authorization may be performed using a point-of-sale terminal. Similarly, if Customer 11 is paying with a personal check, a check authentication process may be performed at a point-of-sale terminal. In some embodiments, Customer 11 will be tendering payment only for the money transfer payment for mobile wireless device prepaid services. In other embodiments, Customer 11 will be tendering payment for the money transfer payment for mobile wireless device prepaid services and also additional items purchased at the store location operating a point-of-sale terminal. In this manner, Customer 11 may accomplish multiple tasks by, for example, purchasing desired groceries or other items available at a store as well as initiating a money transfer payment for mobile wireless device prepaid services.

The advantages of the present invention, including the examples described in conjunction with FIGS. 1 and 2, are numerous. For the consumer, the consumer now has multiple locations at which they can initiate a money transfer payment for mobile wireless device prepaid services. The consumer may multi-task by making a payment for mobile wireless device prepaid services at a location at which they had already planned to purchase groceries or the like. Further, the customer need not endure the lengthy activation typically required with purchasing a prepaid wireless services card associated with the wireless service provider and activating a wireless services prepaid card, but instead can interact with experienced CSRs or systems. As a result, the customer can overcome any language barrier, and receives greater comfort that the money transfer payment for mobile wireless device prepaid services will be effective.

Benefits to the vendor organization are numerous as well. For example, a point-of-sale device can facilitate payment authorization through the receipt of cash. The money transfer payment for mobile wireless device prepaid services host system will receive payments quickly from the vendor through the ACH or other money transfer processing system. In some embodiments, however, money transfer payments for mobile wireless device prepaid services are made through credit card authorization, by certified funds or check authentication processes. The wireless service provider benefits by having customers who are satisfied at having additional locations at which a money transfer payment for mobile wireless device prepaid services may be initiated and paid for, but have the information safely and skillfully collected by the vendor and safely and securely processed by the host system operator.

Still other benefits to the vendor or retailer operating a point-of-sale device exist. First, the vendor or retailer, by participating in this process, is providing an additional service to customers that their competitors may not. This could increase consumer traffic to their store locations. For example, while the above examples describe the user proceeding to a grocery store to purchase items and at the same time initiating a money transfer payment for mobile wireless device prepaid services, the reverse may happen. For example, the customer may proceed to the grocery store to initiate a money transfer payment for mobile wireless device prepaid services, and while they are there purchase items. In addition to the possibility of additional purchases, increased revenue may be received by the merchant through commissions or fees paid by the money transfer payment for mobile wireless prepaid services host system. In one embodiment, the vendor or retailer receives a small fee from the money transfer organization for each money transfer payment for mobile wireless device prepaid services initiated from the vendor location. Still another advantage to the vendor would be the float available to the vendor. The vendor may have in their account the money associated with the money transfer payments for mobile wireless device prepaid services paid by their customers for a period of time before transmission of the money to host system 400. It will be appreciated by those skilled in the art that additional benefits to each of the parties of the methods of the present invention, arising from one or more components of the systems of the present invention may be realized within the scope of the present invention.

The invention has now been described in detail. However, it will be appreciated that the invention may be carried out in ways other than those illustrated in the aforesaid discussion, and that certain changes and modifications may be practiced within the scope of the appended claims. Accordingly, the scope of this invention is not intended to be limited by those specific examples, but rather is to be accorded in the scope represented in the following claims.

What is claimed is:

1. A method of facilitating money transfer payments for mobile wireless device prepaid services, the method comprising:
receiving, from a vendor location, a money transfer payment for mobile wireless device prepaid services fulfillment request including a mobile wireless device phone number and a corresponding payment amount;
identifying, based on the phone number, a destination wireless service provider that serves the mobile wireless device;
formatting the payment for mobile wireless device prepaid services fulfillment request for delivery to the destination wireless service provider to obtain a formatted payment for mobile wireless device prepaid services fulfillment request;
delivering the formatted payment for mobile wireless device prepaid services fulfillment request to a billing system of the destination wireless service provider;
receiving a fulfillment confirmation or denial associated with the formatted payment for mobile wireless device prepaid services fulfillment request; and
when a fulfillment confirmation is received, providing payment for mobile wireless device prepaid services to the destination wireless service provider such that a mobile wireless device prepaid services account associated with the mobile wireless device phone number is credited accordingly.

2. The method of claim 1, wherein the step of receiving the request is performed at a retail outlet.

3. The method of claim 1, wherein an account balance, or payment due, associated with the mobile wireless device phone number is received and returned to a vendor platform.

4. The method of claim 1, wherein an account balance, or payment due, associated with the mobile wireless device phone number is determined and returned to a customer's mobile wireless device via a notification using at least one of short message service (SMS), multimedia message service (MMS) or email.

5. The method of claim 1, wherein the step of identifying comprises querying a wireless number portability database.

6. The method of claim 1, wherein the step of formatting comprises formatting in accordance with a proprietary standard.

7. The method of claim 1, further comprising charging a fee.

8. A system for facilitating money transfer payments for mobile wireless device prepaid services, comprising:
a computer system comprising a processor coupled to a database, wherein the computer system is configured to:
receive a money transfer payment for mobile wireless device prepaid services request including a mobile wireless device phone number and payment amount;
identify, using the database and based on the phone number, a destination wireless service provider that serves the mobile wireless device;
deliver the payment for mobile wireless device prepaid services request to a billing system of the destination wireless service provider;
receive a fulfillment confirmation or denial associated with the payment for mobile wireless device prepaid services request; and
when the a fulfillment confirmation is received, provide money transfer payment for mobile wireless device prepaid services to the wireless service provider.

9. The system of claim 8, wherein the computer system is further configured to associate a mobile wireless device phone number with the destination wireless service provider.

10. The system of claim 8, further comprising a point-of-sale or kiosk device disposed at a vendor location, or placed in a location such that the point-of-sale or kiosk device is made available to the general public, the point-of-sale/kiosk device configured to:
receive a mobile wireless device phone number, the payment amount associated with the mobile wireless device phone number, and a faun of payment;
and provide the money transfer payment for mobile wireless device prepaid services fulfillment request to the computer system.

11. The system of claim 8, wherein the computer system comprises a host computer system located at a location different from a location at which a customer makes a request for the money transfer payment for mobile wireless device prepaid services.

12. The system of claim 8, wherein the database comprises a wireless number portability database.

13. The system of claim 8, further comprising a payment system that is in communication with the billing system of the destination wireless service provider.

14. The system of claim 8, wherein the computer system is further configured to determine an account balance, or payment due, associated with the mobile wireless device phone number and deliver the account balance or payment due to a vendor's platform.

15. The system of claim 8, wherein the computer system is further configured to determine an account balance, or payment due, associated with the mobile wireless device phone number and deliver the account balance or payment due to a customer's mobile wireless device via a notification using at least one of short message service (SMS), multimedia message service (MMS) or email.

16. A method, comprising:
receiving a request, from a local computer system, to add a selected amount of money to a mobile telephone prepaid services account, the request including a mobile telephone number;
identifying, based on the telephone number, a wireless service provider that serves a mobile telephone corresponding to the mobile telephone number;
sending the request to a billing facility of the wireless service provider;
settling, financially, with the billing facility; and
sending a confirmation to the local computer system that the request has been fulfilled.

17. The method of claim 16, wherein the local computer system resides at a vendor location.

18. The method of claim 16, further comprising charging a fee for handling the request.

19. The method of claim 16, further comprising querying a wireless number portability database as part of identifying the wireless service provider.

20. The method of claim 16, further comprising notifying the local computer system when the wireless service provider cannot be identified.

21. The method of claim 16, further comprising updating a cache with information that matches the wireless service provider with the mobile telephone number.

22. The method of claim 16, further comprising maintaining a transactions database.
